(19) United States
(12) Patent Application Publication
(10) Pub. No.: US 2005/0198782 A1
(43) Pub. Date: Sep. 15, 2005

(54) Handle structure of a hand tool

(76) Inventor: Pan-Chung Hsieh, Tou-Liu City (TW)

Correspondence Address: BRUCE H. TROXELL, SUITE 1404, 5205 LEESBURG PIKE, FALLS CHURCH, VA, 22041, US

(21) Appl. No.: 11/068,820

(22) Filed: Mar. 2, 2005

(30) Foreign Application Priority Data
Mar. 9, 2004 (TW) 93203572

(51) Int. Cl. B25B 7/04

(52) U.S. Cl. 16/430

(57) ABSTRACT

A handle structure of a hand tool, having a handle section. The handle section includes a middle bed on which a motor or a mainframe is mounted, two transition sections laterally extending from two sides of the bed and two handles connected with the transition sections. The handles have at least one control button and a wire inlet. A smooth curved face is defined between each transition section and each handle. Each handle has a longitudinally thickened bulge section. The above structure is able to reduce concentration of stress.

### BACKGROUND OF THE INVENTION

The present invention is related to an improved handle structure of a hand tool. The handle structure has smooth curved faces and smooth curved sections adapted to the configuration of human body. In addition, the handle structure is able to reduce concentration of stress.

A conventional self-rotated hand tool has a handle structure. The handle structure can be operated with single hand or both hands. Such handle structure is applicable to an industrial or a daily blender.

For example, Taiwanese Patent Publication No. 431874, entitled “handheld blender” discloses a handle structure which can be operated with single hand. The handle structure includes a housing having a handle. The housing contains an electric motor for rotating a first end of a shaft fitted in a sleeve. A tool is fixed at a second end of the shaft. Taiwanese Patent Publication No. 424580, entitled “blending bar structure of a blender” discloses a handle structure which can be operated with single hand. The blending bar has two blending wings and a chuck barrel. The handle is disposed on a power source for driving the blending bar. The above handles are applied to relatively light self-rotated hand tool such as handheld blender. However, such handles cannot be used in larger or heavier blender or vibrational boring tool.

Taiwanese Patent Publication No. 236177, entitled “blender” discloses a handle structure which is operable with both hands. A handlebar is fitted through the housing of an electric motor for both hands to hold for operating a heavier or larger self-rotated hand tool. Such handlebar lacks any support section or the like for leaning the handlebar on a user's waist or abdomen. Therefore, the user's arms tend to feel tired, especially in operation of vibrational boring or blending of sticking fluid.

FIG. 1 shows another conventional handle structure. A tubular body 20 is bent into a substantially rectangular handle. The handle has two symmetric left and right grips 21, 22 equipped with bushes 23 for a user's hands to hold. The upper and lower beams 24, 25 of the handle are inward recessed and locked on the housing 26 of a power source of a blender. The rectangular handle is symmetrically composed of the coplanar left and right grips 21, 22 and upper and lower beams 24, 25. In operation, a user's both hands hold the left and right grips 21, 22, while the lower beam 25 is leant against the waist or abdomen of the user. By means of the above handle, the user can conveniently operate a heavier or larger self-rotated hand tool without feeling comfortable or tired. However, such handle structure still has some shortcomings. For example, the upper and lower beams 24, 25 are flattened and fixed on the housing 26 with fixing members 27 such as screws. This will ruin the original structural strength of the upper and lower beams 24, 25. Moreover, the left and right grips 21, 22 and upper and lower beams 24, 25. are connected at right angles. This tends to result in concentration of stress. After a long period of use, the portion where the stress is concentrated tends to crack and damage, especially in those vibrational blending or drilling apparatuses.

Therefore, it is tried by the applicant to provide a handle structure having smooth curved configuration for a user to more comfortably operate the hand tool. Also, the handle structure is such designed as to reduce concentration of stress.

### SUMMARY OF THE INVENTION

It is therefore a primary object of the present invention to provide an improved handle structure of a hand tool. The handle structure has smooth curved faces and smooth curved sections adapted to the configuration of human body. In addition, the handle structure is able to reduce concentration of stress.

According to the above object, the handle structure of the present invention has a handle section. The handle section includes a middle bed on which a motor or a mainframe is mounted, two transition sections laterally extending from two sides of the bed and two handles connected with the transition sections. The handles have at least one control button and a wire inlet. A smooth curved face is defined between each transition section and each handle. Each handle has a longitudinally thickened bulge section. The above structure is able to reduce concentration of stress.

The present invention can be best understood through the following description and accompanying drawings wherein:

### BRIEF DESCRIPTION OF THE DRAWINGS

FIG. 1 is a perspective view of a conventional handle structure;

FIG. 2 is a perspective view of the handle structure of the present invention;

FIG. 3 is a front view of the handle structure of the present invention;

FIG. 3-1 is a longitudinal sectional view taken along line A-A of FIG. 3;

FIG. 4 is a top view of the handle structure of the present invention;

FIG. 5 is a right view of the handle structure of the present invention; and

FIG. 6 shows the use of the handle structure of the present invention.

### DETAILED DESCRIPTION OF THE PREFERRED EMBODIMENT

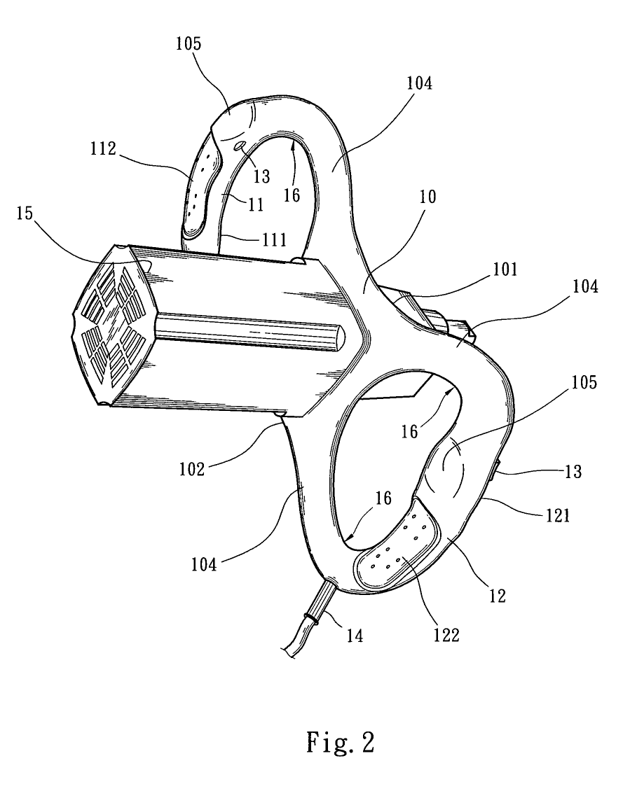

Please refer to FIG. 2. The handle structure of the hand tool of the present invention includes a handle section. The handle section includes a middle bed 10 on which a motor or a mainframe is mounted, two transition sections 104 laterally extending from two sides of the bed 10 and two handles 11, 12 connected with the transition sections 104. The handles have a control button 13 and a wire inlet 14. A smooth curved face 16 is defined between the transition section 104 and the handle 11, 12. Each handle 11, 12 has a longitudinally thickened bulge section 105.

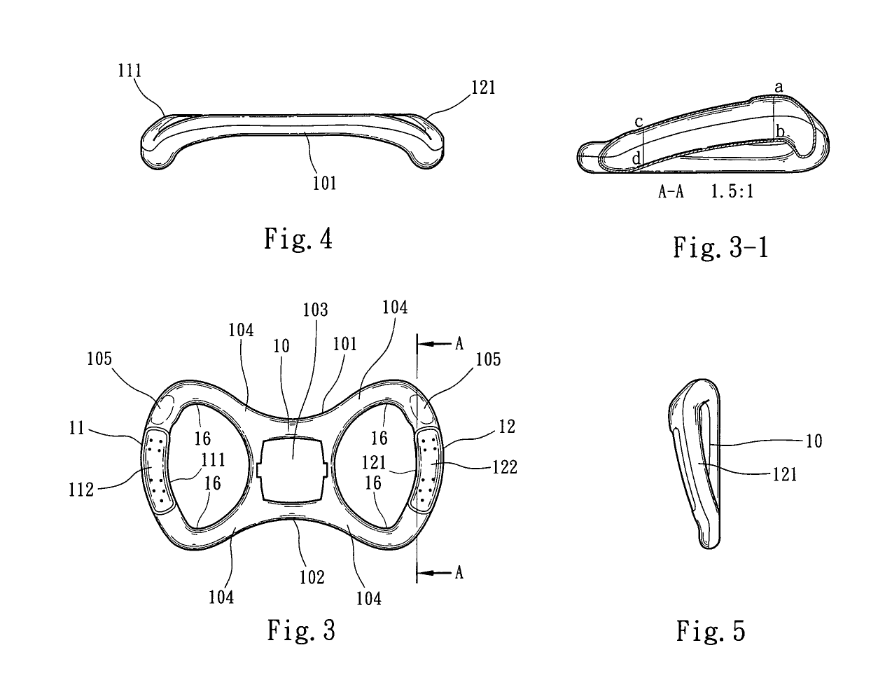

Referring to FIGS. 3 to 5, the bed 10 is formed with a central fitting hole 103 in which the casing 15 of a power source such as a motor or a mainframe is fixedly fitted. The substantially ring-shaped handles 11, 12 symmetrically smoothly leftward and rightward extend from two sides of the bed 10. The handles 11, 12 have an approximately uniform diameter. Outer end face of each of the left and right handles 11, 12 has a smooth curved section 111, 121. Each handle 11, 12 is equipped with at least one control button 13 and a wire inlet 14 of which a control circuit is formed. An upper and a lower smooth saddle faces 101, 102 are defined between the bed 10 and the transition sections 104. The upper and lower saddle faces 101, 102 are adapted to the configuration of human waist and abdomen, whereby a user can have a wider view through the upper saddle face 101 and the lower saddle face 102 be comfortably supported on the user's waist or abdomen.

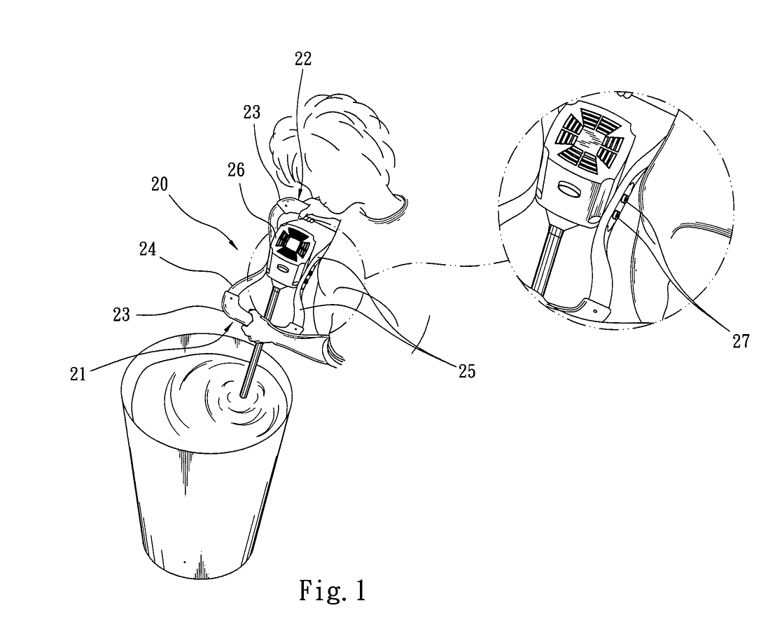

Referring to FIG. 3-1, the diameter of the smooth curved section 111, 121 is slightly tapered from the holding position of the thumb to the holding position of the little finger, that is, the section a-b is larger than the section c-d. Such design is adapted to the holding angle of human hand, whereby a user can more comfortably and conveniently hold and operate the hand tool.

Moreover, slipproof sections 112, 122 are disposed on the outer end faces of the handles 11, 12 for enhancing the friction between the hands and the handles. The control button 13 is disposed on upper side of the outer end face of each handle 11, 12. The control button 13 is an activation switch with locking function. Alternatively, the control button 13 is a torque retrospection device with speed-setting rotary button. The wire inlet 14 can be formed on lower side of the outer end face of the handle 11, 12.

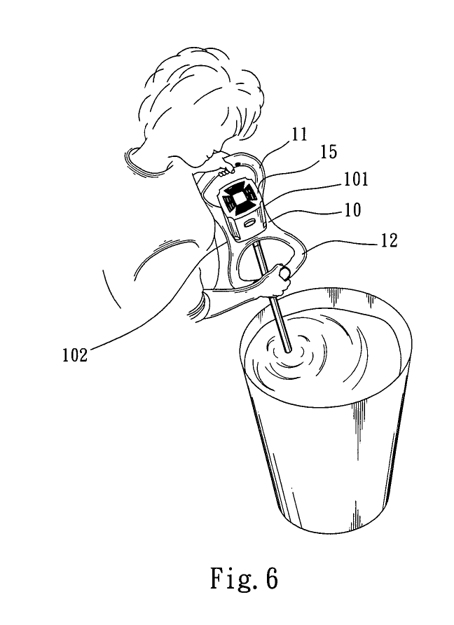

Referring to FIG. 6, the handle structure of the present invention can be applied to a hand tool such as a blender. An operator holds the handles 11, 12 at the slipproof sections 112, 122 with both hands. Then the user leans the lower saddle face 102 against his own waist or abdomen to comfortably support the blender. The user can see through the upper saddle face 101 with a wider view. Then the user switches on the control buttons 13 disposed on the left and right handles 11, 12 with both hands to go at the blending operation.

According to the above arrangement, the present invention has the following advantages:
1. The ring-shaped handles symmetrically laterally extend from left and right sides of the bed 10. The smooth curved face 16 is defined between the transition section 104 and the handle 11, 12. Each handle 11, 12 has a thickened bulge section 105. The above structure is able to reduce concentration of stress.
2. The upper and lower smooth saddle faces 101, 102 are defined between the bed 10 and the transition sections 104. The upper and lower saddle faces 101, 102 are adapted to the configuration of human waist and abdomen. Therefore, a user can have a wider view through the upper saddle face 101 and the lower saddle face 102 be comfortably supported on the user's waist or abdomen.
3. The outer end face of each of the left and right handles 11, 12 has an upward inclined smooth curved section 111, 121. The diameter of the smooth curved section 111, 121 is slightly tapered from the holding position of the thumb to the holding position of the little finger. Such design is adapted to the holding angle of human hand, whereby a user can more comfortably hold the hand tool.

The above embodiment is only used to illustrate the present invention, not intended to limit the scope thereof. Many modifications of the above embodiment can be made without departing from the spirit of the present invention.

1. A handle structure of a hand tool, comprising a handle section, the handle section including a middle bed on which a motor or a mainframe is mounted, two transition sections laterally extending from two sides of the bed and two handles connected with the transition sections, the handles having at least one control button and a wire inlet, a smooth curved face being defined between each transition section and each handle, each handle having a longitudinally thickened bulge section.

2. The handle structure of the hand tool as claimed in claim 1, wherein an upper and a lower smooth saddle faces are defined between the bed and the transition sections, the upper and lower saddle faces being adapted to the configuration of human waist and abdomen, whereby a user can have a wider view through the upper saddle face and the lower saddle face be comfortably supported on the user's waist or abdomen.

3. The handle structure of the hand tool as claimed in claim 2, wherein outer end faces of the left and right handles are symmetrically formed with upward inclined smooth curved sections.

4. The handle structure of the hand tool as claimed in claim 3, wherein slipproof sections are disposed on the outer end faces of the handles.

5. The handle structure of the hand tool as claimed in claim 1, wherein the control button is disposed at upper end of each handle, the control buttons being an activation switch with locking function and a torque retrospection device with speed-setting rotary button.

6. The handle structure of the hand tool as claimed in claim 2, wherein the control button is disposed at upper end of each handle, the control buttons being an activation switch with locking function and a torque retrospection device with speed-setting rotary button.

7. The handle structure of the hand tool as claimed in claim 3, wherein the control button is disposed at upper end of each handle, the control buttons being an activation switch with locking function and a torque retrospection device with speed-setting rotary button.

8. The handle structure of the hand tool as claimed in claim 4, wherein the control button is disposed at upper end of each handle, the control buttons being an activation switch with locking function and a torque retrospection device with speed-setting rotary button.

9. The handle structure of the hand tool as claimed in claim 1, wherein the wire inlet is formed at lower end of each handle.

10. The handle structure of the hand tool as claimed in claim 2, wherein the wire inlet is formed at lower end of each handle.

11. The handle structure of the hand tool as claimed in claim 3, wherein the wire inlet is formed at lower end of each handle.

12. The handle structure of the hand tool as claimed in claim 4, wherein the wire inlet is formed at lower end of each handle.

13. The handle structure of the hand tool as claimed in claim 1, wherein the bed is formed with a central fitting hole in which a motor or a mainframe is fixedly fitted.

14. The handle structure of the hand tool as claimed in claim 2, wherein the bed is formed with a central fitting hole in which a motor or a mainframe is fixedly fitted.

15. The handle structure of the hand tool as claimed in claim 3, wherein the bed is formed with a central fitting hole in which a motor or a mainframe is fixedly fitted.

16. The handle structure of the hand tool as claimed in claim 4, wherein the bed is formed with a central fitting hole in which a motor or a mainframe is fixedly fitted.
